(19) United States
(12) Patent Application Publication
(10) Pub. No.: US 2026/0204659 A1
(43) Pub. Date: Jul. 16, 2026

(54) PVA SOLUTION FOR IN-SITU PRODUCTION OF AN ANODE INTERLAYER AND METHOD OF MANUFACTURING AN ANODE-FREE ALL-SOLID-STATE BATTERY INLCUDING THE ANODE INTERLAYER

(71) Applicant: SAMSUNG SDI CO., LTD., Yongin-si (KR)

(72) Inventors: Hoyoung Lee, Cambridge, MA (US); Forrest Gittleson, Cambridge, MA (US); Yang Li, Cambridge, MA (US); Catherine Haslam, Cambridge, MA (US); Singyuk Hou, Cambridge, MA (US); Jungjoon Kim, Cambridge, MA (US); Yongseok Kim, Cambridge, MA (US); Seungman Park, Yongin-si (KR); Jaehou Nah, Yongin-si (KR)

(21) Appl. No.: 19/355,618

(22) Filed: Oct. 10, 2025

Related U.S. Application Data
(60) Provisional application No. 63/745,525, filed on Jan. 15, 2025.

(51) Int. Cl. H01M 10/42; C09D 5/24; C09D 7/40; C09D 7/61; C09D 129/04; H01M 4/04; H01M 4/66

(52) U.S. Cl. CPC H01M 10/4235; C09D 5/24; C09D 7/61; C09D 7/67; C09D 129/04; H01M 4/0404; H01M 4/661

(57) ABSTRACT

An interlayer including a binder, nanoparticles, and a carbonaceous material, an anodeless battery including the interlayer, and a method of manufacturing the interlayer are provided. The binder may be soluble in water of non-aqueous organic solvents and is functionalized with moieties including H-bond donors, H-bond acceptors, acids, and/or bases, having at most about 20 mol % of negatively charged moieties, based on a total moles of the binder. The anodeless battery includes the interlayer between a solid-state electrolyte and a current collector. The method includes mixing the carbonaceous material, a redox active compound, and the binder to form a slurry that is applied to a current collector and heat treated to provide the interlayer including the nanoparticles.

### CROSS-REFERENCE TO RELATED APPLICATION

This application claims priority to and the benefit of U.S. Provisional Patent Application Ser. No. 63/745,525, filed on Jan. 15, 2025, the entire content of which is incorporated herein by reference.

### BACKGROUND AND FIELD

An all-solid-state battery (ASSB) is considered a next-generation energy storage system because it has potential to provide superior safety characteristics and higher energy density compared to a lithium-ion batteries (LIB). The ASSB includes a solid-state electrolyte to mitigate electrolyte leakage, thermal runaway, combustion, and other the safety issues associated with flammable solvents used in an LIB. Sulfide-based argyrodite materials including Li₆PS₆Cl, Li₆PS₆Br, Li₆PS₆I, and/or the like are promising solid-state electrolytes that have high ionic conductivity and favorable mechanical properties. Despite these advantages, ASSBs utilizing a lithium metal anode still face significant challenges, including dendrite formation, uneven lithium deposition, and interfacial instability, which may decrease Coulombic efficiency and battery cycle life.

An anodeless ASSB featuring no lithium metal on the anode current collector when manufactured is an efficient approach to increase energy density. Lithium metal is plated directly to the anode current collector during the first charge of the anodeless ASSB. This design simplifies cell structure but has disadvantages such as non-uniform lithium deposition, deposition of inactive (e.g., dead) lithium, and rapid interfacial degradation.

One strategy to overcome these challenges includes an interlayer between the anode current collector and the solid-state electrolyte that facilitates uniform lithium plating. Silver-carbon (AgC) composites are highly promising for use as an interlayer because silver forms alloys with lithium readily and reduces the energetic nucleation barrier, while carbon provides electronic conductivity and mechanical support. However, existing fabrication methodology of AgC interlayers require multiple synthetic procedures, organic additives, and complicated mixing processes that limit scalability and increase manufacturing costs.

The need exists for a simple and scalable approach to manufacture AgC interlayers that promote stable lithium plating for anodeless ASSBs.

### SUMMARY

One or more embodiments of the present disclosure relate to a composite interlayer including carbon and metal nanoparticles, an anodeless battery including the interlayer, a method of manufacturing the interlayer, and a method of operating the anodeless battery.

The interlayer is prepared from a slurry including a carbonaceous material, a metal precursor, and a polymeric binder and applied to a negative electrode current collector followed by a mild heat treatment process. The foregoing may be a single act process that provides metal nanoparticles having uniform size (e.g., substantially uniform size) and requires no chemical additives, e.g., oxidants, reductants, stabilizers and/or the like. If (e.g., when) used in an anodeless solid-state battery the interlayer facilitates the migration of metal cations out of a solid-state electrolyte and reduction to a solid metal that is deposited on the negative electrode current collector to form a plated anode.

Embodiments of the present disclosure provide several features including: integration of slurry formation and nanoparticle synthesis into a single act thereby reducing processing costs; a functionalized, non-ionic binder that avoids or reduces gel formation of the metal precursor; enhanced homogeneity of the metal nanoparticles throughout the interlayer; and increased rate performance and cycling stability of the anodeless battery.

Further features provided by embodiments of the present disclosure will be described herein but are not limited to the following description.

According to one or more embodiments of the present disclosure, an interlayer for an anodeless battery includes a binder, nanoparticles, and a carbonaceous material.

In one or more embodiments, the binder may be water-soluble, soluble in non-aqueous organic solvents, or a combination thereof, and may include moieties, the moieties that may be hydrogen bond donor groups, hydrogen bond acceptor groups, acidic groups, basic groups, or combinations thereof, and the moieties may include at most about 20 mol % of negatively charged groups, based on a total moles of the binder.

In one or more embodiments, the binder may include a polymer composition having at least about 50 mol % of hydrogen bond donor groups, based on a total moles of the binder.

In one or more embodiments, the binder may include a polyvinyl alcohol (PVA) composition having at least about 50 mol % of hydroxyl groups, based on a total moles of the binder.

In one or more embodiments, the polymer composition may have an average molecular weight of at least about 10,000 Dalton (D).

In one or more embodiments, the nanoparticles may include a metal, a metalloid, an alloy thereof, a compound thereof, or combinations thereof.

In one or more embodiments, the nanoparticles may include silver, gold, platinum, tellurium, antimony, germanium, bismuth, tin, tungsten, molybdenum, cobalt, nickel, copper, iron, or combinations thereof.

In one or more embodiments, an average diameter of the nanoparticles may be at least about 5 nanometers (nm).

In one or more embodiments, the carbonaceous material may include amorphous carbon, graphite, graphene, reduced graphene oxide, carbon nanotube, or combinations thereof.

In one or more embodiments, the interlayer may include, based on a total weight of the interlayer: about 5 wt % to about 95 wt % of the carbonaceous material; about 0.1 wt % to about 50 wt % of the nanoparticles; and about 0.01 wt % to about 10 wt % of the binder.

In one or more embodiments, a thickness of the interlayer may be about 1 micrometer (μm) to about 30 μm.

According to one or more embodiments of the present disclosure, an anodeless battery includes a positive electrode, a negative electrode current collector, an electrolyte, and an interlayer as described herein between the electrolyte and the negative electrode current collector.

In one or more embodiments, the negative electrode current collector may include stainless steel, iron, nickel, manganese, copper, titanium, aluminum, or combinations thereof.

According to one or more embodiments of the present disclosure, a method of manufacturing an interlayer includes providing a carbonaceous material, a redox active compound, and a binder to form a slurry, mixing the slurry, applying the slurry to a current collector, and heat treating the slurry to provide the interlayer including the nanoparticles.

In one or more embodiments, the providing of the redox active compound may include providing at least one compound including a metal, a metalloid, or combinations thereof.

In one or more embodiments, the providing of the redox active compound may include providing at least one compound including silver.

In one or more embodiments, the providing of the current collector may include a negative electrode current collector or a positive electrode current collector.

According to one or more embodiments of the present disclosure, an anodeless battery includes a positive electrode including a cathode active material, a negative electrode current collector, a solid-state electrolyte between the positive electrode and the negative electrode current collector, an interlayer including a binder, nanoparticles, and a carbonaceous material, and a method of operating the anodeless battery includes charging the anodeless battery to provide a plated anode.

In one or more embodiments, the plated anode may include metal elements, metal alloys, metal compounds, or combinations thereof.

In one or more embodiments, the method may include discharging the anodeless battery to remove the plated anode.

Additional aspects of embodiments will be set forth in part in the description which follows and, in part, will be apparent from the description, or may be learned by practice of the presented embodiments of the disclosure.

### BRIEF DESCRIPTION OF THE DRAWINGS

The preceding and other objects and features of embodiments of the present disclosure will become more apparent to those of ordinary skill in the art by describing example embodiments thereof in more detail with reference to the accompanying drawings. In the drawings:

FIG. 1 is a cutaway perspective view schematically showing a rechargeable lithium battery according to one or more embodiments.

FIG. 2 is a cross-sectional view schematically showing a rechargeable lithium battery according to one or more embodiments.

FIG. 3 and FIG. 4 are perspective views schematically showing rechargeable lithium batteries according to one or more embodiments.

FIG. 5 is a schematic view of an anodeless battery including an interlayer according to one or more embodiments of the present disclosure.

FIG. 6 includes transmission electron microscopy (TEM) images of interlayers according to one or more embodiments of the present disclosure.

FIG. 7A and FIG. 7B are charts of X-ray powder diffraction (XRD) analysis of interlayers according to one or more embodiments of the present disclosure.

FIG. 8A and FIG. 8B are charts of the electrochemical performance of interlayers according to one or more embodiments of the present disclosure.

FIG. 9 is a chart of the electrochemical lithium plating and stripping performance of an anodeless battery including an interlayer according to one or more embodiments of the present disclosure.

FIG. 10 is a chart of the electrochemical lithium plating and stripping performance of a comparative anodeless battery that does not include an interlayer.

### DETAILED DESCRIPTION

In order to sufficiently understand the configuration and effect of embodiments of the present disclosure, example embodiments of the present disclosure will be described in more detail with reference to the accompanying drawings, and may be easily practiced by a person skilled in the art. However, it should be noted that this is provided by way of example, and the present disclosure is not limited thereby and is only defined by the scope of the appended claims, and equivalents thereof, described in more detail herein. Rather, the example embodiments are provided only to disclose the subject matter of the present disclosure and let those skilled in the art fully know the scope of the present disclosure.

Unless stated otherwise in the specification, singular expressions may include plural expressions. Also, unless stated otherwise, “A or B” may refer to “including A, including B, or including A and B.”

In the specification, a “combination thereof” may refer to a mixture, laminate, composite, copolymer, alloy, blend, and/or reaction product of constituents.

The terms “comprises,” comprising,” “comprise,” “including,” “includes,” “include,” “having,” “has,” and “have,” as used in this description, are intended to designate the presence of an embodied aspect, number, act, task, element, and/or a (e.g., any suitable) combination thereof. However, the use of these terms does not preclude or exclude the possibility of the presence or addition of one or more other components, features, numbers, acts, tasks, elements, and/or a (e.g., any suitable) combination thereof.

In one or more embodiments, the term “layer” herein includes not only a shape formed or provided on the whole surface if viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device may be calculated. As utilized herein, if (e.g., when) a definition is not otherwise provided, the average particle diameter refers to a diameter (D50) of particles having a cumulative volume of 50 volume % in the particle size distribution that is obtained by measuring the size (diameter or major axis length) of about 200 particles at random in a transmission electron microscopic image.

The preceding and other objects and features of embodiments of the present disclosure will become more apparent to those of ordinary skill in the art by describing example embodiments thereof in more detail with reference to the accompanying drawings. In the drawings, the thickness of layers, films, panels, regions, and/or the like, may be exaggerated for clarity and like reference numerals designate like elements throughout, and duplicative descriptions thereof may not be provided in the specification. Unless stated otherwise in the specification, if a portion of a layer, film, region, plate and/or the like is referred to as being “on” another portion, this includes not only the case in which the portion is “directly on” another portion but also the case in which there is another portion interposed therebetween.

The following description includes non-limiting examples of values for quantities that are a part of the present disclosure. The example values are described as example ranges for the quantities and it will be understood that any and all of the following example ranges may include any sub-range beginning and/or ending with any value thereof. An example range of “about 60% to about 80%” may also include, for example, about 60.0% to about 75%, about 68% to about 80.0%, about 68% to about 72%, about 69.5% to about 70.5%, about 70.0%, and about 70%.

### Nanocomposite Interlayer

An interlayer according to one or more embodiments of the present disclosure is for use in an anodeless battery, e.g., the anodeless battery may be an anodeless all-solid-state battery (ASSB), such as an anodeless all-solid-state lithium metal battery (ASSLMB) and/or the like, but the present disclosure is not limited thereto. In one or more embodiments, the interlayer includes a binder, nanoparticles and a carbonaceous material.

The binder may be a liquid and/or solid and may be water-miscible, water-soluble, soluble in non-aqueous organic solvents, or a combination thereof, but the present disclosure is not limited thereto. The binder includes moieties (e.g., chemical functional groups) that may be polar and/or non-polar, may be selected from among hydrogen bond donor groups, hydrogen bond acceptor groups, acidic groups, basic groups, and/or combinations thereof. The hydrogen bond donor groups may be amines, halides, hydroxyl groups, sulfides, and/or the like, but the present disclosure is not limited thereto.

The binder may include at most about 20 mol % of negatively charged groups, based on total moles of the binder. For example, the negatively charged groups may be carboxylate groups, carbonate groups, and/or the like, but the present disclosure is not limited thereto. In one or more embodiments, the binder may include 0 mol % to about 20 mol %, about 0.5 mol % to about 10 mol %, or about 1 mol % to about 2 mol % of negatively charged groups. In one or more embodiments, the binder may have substantially no negatively charged groups, e.g., the binder may be free of negatively charged groups. For example, the binder may be substantially free of charged groups such that charged groups may only be present, if at all, in the binder as an incidental impurity. In one or more embodiments, the binder may have substantially no carboxylate groups and/or no carbonate groups, e.g., the binder may be free of carboxylate groups and/or carbonate groups. For example, the binder may be substantially free of carboxylate groups and/or carbonate groups such that carboxylate groups and/or carbonate groups may only be present, if at all, in the binder as an incidental impurity.

In one or more embodiments, the binder may be or include a polymer composition that may have at least about 50 mol % of hydrogen bond donor groups, based on a total moles of the binder. For example, the binder may include about 50 mol % to about 99.5 mol %, about 70 mol % to about 99 mol %, or about 85 mol % to about 95 mol % of hydrogen bond donor groups, based on a total moles of the binder.

In one or more embodiments, the binder may be or include a polyvinyl alcohol (PVA) composition that may be a hydrolysis product of polyvinyl acetate (PVAA). The PVA composition may be a hydrolyzed PVAA having a degree of hydrolysis of about 50% to about 99.8%, about 70% to about 99.5%, or about 88% to about 99%. In one or more embodiments, the PVA composition may have at least about 50 mol % of hydroxyl groups, based on a total moles of the binder (e.g., the PVA composition). For example, the PVA composition may have about 50 mol % to about 99.8 mol %, about 70 mol % to about 99.5 mol %, or about 88 mol % to about 99 mol % of hydroxyl groups, based on a total moles of the binder (e.g., the PVA composition).

In one or more embodiments, the binder may further include polyethylene glycol, polypropylene glycol, polydimethylsiloxane or combinations thereof, in addition to the PVA composition.

In one or more embodiments, the polymer composition (e.g., PVA composition) may have an average molecular weight of at least about 10,000 g/mol, but the present disclosure is not limited thereto. For example, the average molecular weight of the PVA composition may be about 10 kg/mol to about 800 kg/mol, about 80 kg/mol to about 300 kg/mol, about 130 kg/mol to about 170 kg/mol, or about 140 kg/mol to about 160 kg/mol.

In one or more embodiments, the polymer composition (e.g., PVA composition) may have a density of about 1.33 grams per cubic centimeter (g/cc), but the present disclosure is not limited thereto. For example, the density of the PVA composition may be about 0.9 g/cc to about 1.8 g/cc, about 1 g/cc to about 1.5 g/cc, about 1.1 g/cc to about 1.4 g/cc, or about 1.20 g/cc to about 1.30 g/cc.

The nanoparticles may include at least one metal, at least one metalloid, an alloy thereof, a compound thereof, or combinations thereof. The compound may be an ionic compound (e.g., salt) and/or a molecular compound (e.g., covalent compound excluding ionic bonds) including the metal and/or metalloid. In one or more embodiments, the nanoparticles may be or include silver, gold, platinum, tellurium, antimony, germanium, bismuth, tin, tungsten, molybdenum, cobalt, nickel, copper, iron, alloys of at least two thereof, and/or combinations thereof. For example, the nanoparticles may be metallic (e.g., elemental) silver. In one or more embodiments, the nanoparticles may include elements other than metallic (e.g., elemental) silver in at most 100 parts per million (ppm), e.g., about 1 ppm to about 50 ppm, or about 5 ppm to about 30 ppm.

In one or more embodiments, an average particle diameter (D50) of the nanoparticles may be at least about 5 nanometer (nm), but the present disclosure is not limited thereto. For example, the average particle diameter (D50) of the nanoparticles may be about 5 nm to about 500 nm, about 10 nm to about 300 nm, about 20 nm to about 150 nm, about 25 nm to about 100 nm, about 25 nm to about 70 nm, about 20 nm to about 60 nm, about 35 nm to about 60 nm, about 40 nm to about 60 nm, about 45 nm to about 6 nm, or about 50 nm to about 60 nm.

In one or more embodiments, a crystalline form of the interlayer and/or nanoparticles exhibits an X-ray powder diffraction pattern including at least one characteristic peak. For example, the characteristic peak may be selected from among approximately 38.2, approximately 44.3, and approximately 64.3 degrees 2θ.

In one or more embodiments, the carbonaceous material may include amorphous carbon, graphite, graphene, reduced graphene oxide, carbon nanotube, combinations thereof, and/or the like, but the present disclosure is not limited thereto. In one or more embodiments, the carbonaceous material may be or include carbon powder.

In one or more embodiments, the interlayer includes about 1 wt % to about 99.5 wt %, about 5 wt % to about 95 wt %, about 5 wt % to about 80 wt %, about 5 wt % to about 60 wt %, about 10 wt % to about 50 wt %, or about 40 wt % to about 90 wt % of the carbonaceous material, based on a total weight of the interlayer.

In one or more embodiments, the interlayer includes about 0.01 wt % to about 99 wt %, about 0.1 wt % to about 50 wt %, about 0.1 wt % to about 20 wt %, or about 1 wt % to about 10 wt % of the nanoparticles, based on a total weight of the interlayer. In one or more embodiments, a weight ratio of an amount of the nanoparticles to an amount of the carbonaceous material may be about 1 to about 100, e.g., about 1 to about 60, about 1 to about 50, about 1 to about 20, about 1 to about 10, or about 1 to about 5.

In one or more embodiments, the interlayer includes about 0.01 wt % to about 99 wt %, about 0.01 wt % to about 50 wt %, about 0.1 wt % to about 25 wt %, about 1 wt % to about 15 wt %, about 3 wt % to about 10 wt %, or about 4 wt % to about 8 wt % of the binder, based on a total weight of the interlayer. In one or more embodiments, a weight ratio of an amount of the binder to an amount of the nanoparticles may be about 1 to about 100, e.g., about 1 to about 60, about 1 to about 50, about 1 to about 20, about 1 to about 10, or about 1 to about 5.

In one or more embodiments, the interlayer may be or include a matrix (e.g., nanocomposite matrix) that may include the nanoparticles and the carbonaceous material. For example, the matrix (e.g., nanocomposite matrix) may be a matrix of the carbonaceous material and the nanoparticles may be embedded in the matrix.

In one or more embodiments, the matrix (e.g., nanocomposite matrix) may include oxidized carbon compounds. Not wishing to be limited by any particular mechanism or theory, the nanoparticles and the oxidized carbon compounds may be redox pairs, e.g., the nanoparticles being a product of reduction and the oxidized carbon compounds being a product of oxidation. An amount of the oxidized carbon compounds in the interlayer and/or the matrix may be substantially the same as the amount of the nanoparticles. In one or more embodiments, the interlayer and/or the matrix includes about 0.01 wt % to about 99 wt %, about 0.1 wt % to about 50 wt %, about 0.1 wt % to about 20 wt %, or about 1 wt % to about 10 wt % of the oxidized carbon compounds, based on a total weight of the interlayer and/or the matrix.

In one or more embodiments, a thickness of the nanocomposite interlayer may be about 1 micrometer (μm) to about 30 μm. For example, the thickness of the nanocomposite interlayer may be about 1 μm to about 25 μm, about 2 μm to about 20 μm, about 3 μm to about 15 μm, or about 4 μm to about 12 μm.

### Anodeless Battery

An anodeless battery according to one or more embodiments of the present disclosure may be an anodeless all-solid-state battery (ASSB), such as an anodeless all-solid-state lithium metal battery (ASSLMB). The term “anodeless battery” as used herein is a battery that excludes a permanent anode (e.g., negative electrode) and may include a plated anode (e.g., negative electrode) that is a transient structure, as described in more detail elsewhere herein. The ASSLMB of embodiments of the present disclosure may be rechargeable and may be applied in vehicles, electric vehicles, mobile phones, electronic devices, and/or the like but the present disclosure is not limited thereto.

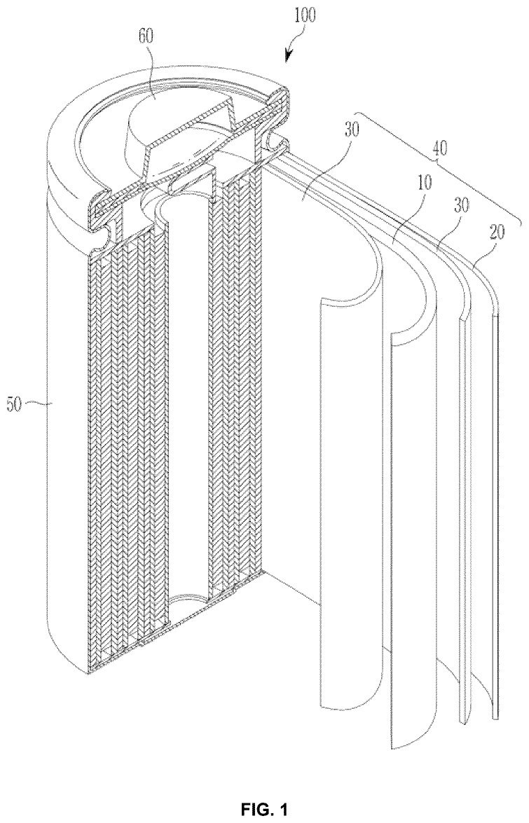

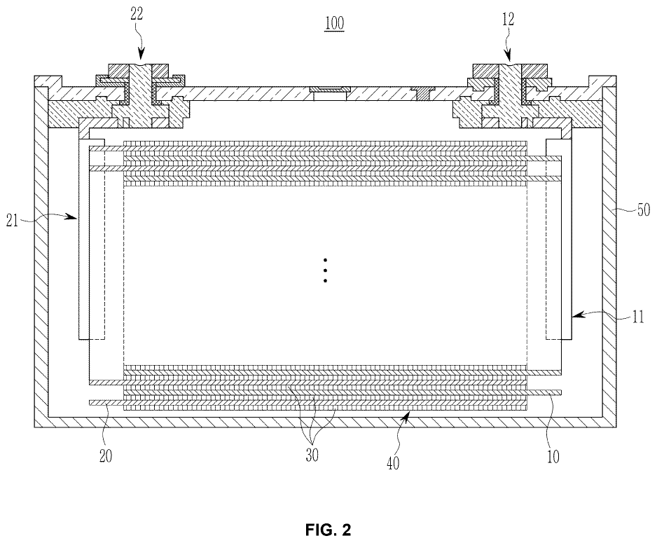

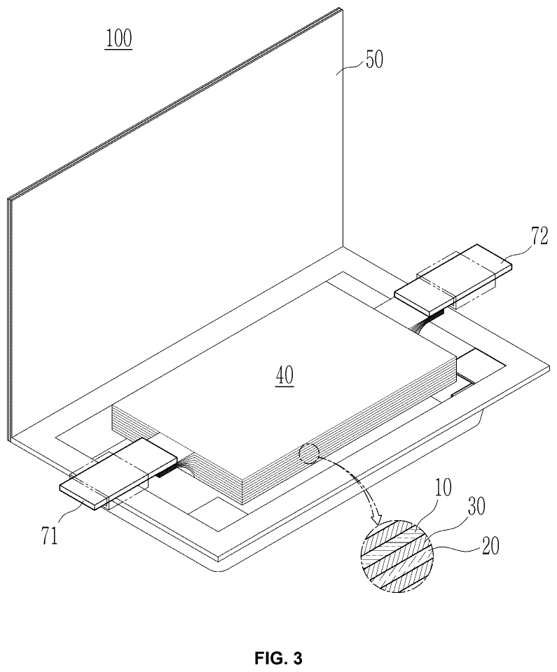

The anodeless battery may be classified into cylindrical, prismatic, pouch, coin, and/or the like, depending on the shape of the rechargeable lithium battery. FIGS. 1-4 are schematic diagrams showing the anodeless battery according to one or more embodiments, where FIG. 1 is a cylindrical battery, FIG. 2 is a prismatic battery, and FIGS. 3-4 are each a pouch-shaped battery. Referring to FIGS. 1-4, the anodeless battery 100 includes an electrode assembly 40 with a separator 30 between the positive electrode (cathode) 10 and the negative electrode (anode) 20, and a case 50 in which the electrode assembly 40 is housed. The positive electrode (cathode) 10, the negative electrode (anode) 20, and the separator 30 may be impregnated with an electrolyte. The anodeless battery 100 may include a sealing member 60 that seals the case 50 as shown in FIG. 1. In FIG. 2, the anodeless battery 100 may include a positive electrode (cathode) lead tab 11, a positive terminal 12, a negative electrode (anode) lead tab 21, and a negative terminal 22. As shown in FIGS. 3-4, the anodeless battery 100 includes electrode tabs 70, that may be a positive electrode (cathode) tab 71 and a negative electrode (anode) tab 72, that serve as an electrical path to induce the current formed in the electrode assembly 40 to the outside.

The anodeless battery of the present disclosure includes a positive electrode having a positive electrode active material (e.g., cathode active material (CAM)). In one or more embodiments, CAM may be a nickel composite oxide (e.g., layered nickel composite oxide) including nickel, oxygen, and about one to about five elements selected from among aluminum (AI), boron (B), cobalt (Co), iron (Fe), magnesium (Mg), manganese (Mn), titanium (Ti), tungsten (W), and/or a (e.g., any suitable) combination thereof. In one or more embodiments, the CAM may be a lithium nickel composite oxide, a lithium nickel-cobalt-aluminum composite oxide (NCA-based composite oxide), and/or a lithium nickel-manganese-cobalt-based composite oxide (NMC-based composite oxide). The term “based composite oxide,” as used herein, is a CAM oxide material that includes elements (e.g., metal elements) in addition to the elements in the name of the CAM. In one or more embodiments, the CAM may be lithium nickel oxide (LiNiO₂), lithium nickel cobalt aluminum oxide (NCA) (LiNiCoAlO₂), lithium nickel manganese cobalt oxide (NMC) (LiNiCoMnO₂), or a (e.g., any suitable) combination thereof. For example, the nickel composite oxide may be at least one selected from among LiNi_{0.94}Co_{0.02}A_{0.04}O₂ (NCA94), LiNi_{0.85}Co_{0.10}Mn_{0.05}O₂ (NCM 851005), LiNi_{0.8}Co_{0.1}Mn_{0.1}O₂ (NCM 811), and LiNi_{0.6}Co_{0.2}Mn_{0.2}O₂ (NCM 622).

The nickel composite oxide may include a mole fraction of at least about 0.80 nickel, based on a total molar composition of the nickel composite oxide. In one or more embodiments, the mole fraction of nickel may be about 0.05 to about 0.999, about 0.80 to about 0.999, about 0.85 to about 0.99, or about 0.90 to about 0.95, based on a total molar composition of the nickel composite oxide.

The anodeless battery includes the interlayer of embodiments of the present disclosure and a negative electrode current collector and the interlayer may on the negative electrode current collector. The negative electrode current collector may be or include a metal foil. In one or more embodiments, the negative electrode current collector may include stainless steel, iron, nickel, manganese, copper, titanium, aluminum, or combinations thereof. In one or more embodiments, the negative electrode current collector includes an amount of unspecified trace elements of less than about 1%, e.g. about 10 ppm to about 5000 ppm.

### Electrolyte

The anodeless battery of embodiments of the present disclosure includes an electrolyte between the positive electrode and the interlayer and the interlayer may be between the electrolyte and the negative electrode current collector. In one or more embodiments, the electrolyte may be or include a solid-state electrolyte (e.g., all-solid electrolyte) that includes any material suitable for use as an ion conductive material. Non-limiting examples of the solid-state electrolyte may include an inorganic solid-state electrolyte, a crystalline solid-state electrolyte, an amorphous solid-state electrolyte, a polymeric solid-state electrolyte, or a combination thereof.

In one or more embodiments, the solid-state electrolyte may be a sulfide-based solid-state electrolyte, an oxide-based solid-state electrolyte, a lithium aluminum titanium phosphate (LATP) solid-state electrolyte, an anti-perovskite solid-state electrolyte, or a combination thereof. The sulfide-based solid-state electrolyte may include, for example, Li, S, and P and may optionally further include a halogen element. The sulfide-based solid-state electrolyte may be selected from sulfide-based solid-state electrolytes utilized in an electrolyte layer. For example, the sulfide-based solid-state electrolyte may have an ionic conductivity of at least about 1×10⁻⁵ Siemens per centimeter (S/cm) at room temperature. The oxide-based solid-state electrolyte may include, for example, Li, O, and a transition metal element and may optionally further include other elements. For example, the oxide-based solid-state electrolyte may be a solid-state electrolyte having an ionic conductivity of at least about 1×10⁻⁵ S/cm at room temperature. The oxide-based solid-state electrolyte may be selected from oxide-based solid-state electrolytes suitable for use in an electrolyte layer.

In one or more embodiments, the solid-state electrolyte may include at least one selected from among LipPSnX, Li₂S—P₂S₅, Li₂S—P₂S₅—LiX, Li₂S—P₂S₅—Li₂O, Li₂S—P₂S₅—Li₂O—LiI, Li₂S-SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn, Li₂S—GeS₂, Li₂S—SiS₂—Li₃PO₄, Li₂S—SiS₂-LiₚMO_{q}, and a combination thereof. For example, X may be a halogen, Z may be Ge, Zn, or Ga, M may be P, Si, Ge, B, Al, Ga, or In, and m, n, p, and q may each independently be a positive integer. The solid-state electrolyte may include at least one compound of formula LipPSnX, having p of 1 to 6, n of 1 to 5, and X may be F, Cl, Br or I. For example, the solid-state electrolyte may include Li₆PS₅F, Li₆PS₅Cl, Li₆PS₅Br, and/or Li₆PS₅I.

### Method of Manufacturing an Interlayer

Methods of manufacturing an interlayer according to one or more embodiments of the present disclosure include providing a redox active compound, and the carbonaceous material and binder as described herein to form a slurry. The redox active compound may be at least one compound comprising a metal, a metalloid, or combinations thereof. The redox active compound may be an ionic compound (e.g., salt) and/or a molecular compound (e.g., covalent compound excluding ionic bonds) including the metal and/or metalloid. The metal of the redox active compound may be an alkali metal, an alkaline earth metal, a transition metal, or combinations thereof. In one or more embodiments, the metal of the redox active compound may be silver, gold, platinum, tellurium, antimony, germanium, bismuth, tin, tungsten, molybdenum, cobalt, nickel, copper, and/or iron. For example, the redox active compound may be at least one compound including silver, e.g., silver nitrate, but the present disclosure is not limited thereto. In one or more embodiments, the redox active compound may include metals other than silver in at most 100 parts per million (ppm), e.g., about 1 ppm to about 50 ppm, or about 5 ppm to about 30 ppm.

The methods include mixing the slurry and distributing the redox active compound substantially uniformly within the carbonaceous material, e.g., by mixing with agitation suitable or sufficient to provide the slurry as a homogeneous and flowable slurry. For example, the slurry may be mixed in a centrifugal mixer or planetary mixer and at a mixing speed may at least about 1000 rpm.

The methods include applying (e.g., coating) the slurry to a current collector, e.g., a negative electrode current collector or a positive electrode current collector. The slurry may be applied with a doctor blade, but the present disclosure is not limited thereto. In one or more embodiments, the slurry may be applied using spin cast, tape casting, and/or roll-to-roll coating technology. The non-ionic polar functional groups of the binder avoid undesired gelation of the slurry and facilitate stable dispersion and uniform (e.g., substantially uniform) coating of the slurry onto the current collector. For example, the non-ionic polar functional groups may be hydrogen bond donor groups such as hydroxyl groups, but the present disclosure Is not limited thereto.

The methods include heat treating the slurry to provide (e.g., produce) the nanoparticles distributed substantially uniformly within the matrix, as described in more detail herein. The slurry may be heat treated at a temperature of about 40° C. to about 1000° C., about 80° C. to about 200° C., about 100° C. to about 140° C., or at about 120° C. The slurry may be heat treated for about 5 minutes to about 3 days, or about 1 hour (h) to about 48 h, about 4 h to about 36 h, or about 20 hour to about 24 h. Not wishing to be limited by any particular mechanism or theory, the redox active compound (e.g., AgNO₃) may be reduced during heat treating to provide nanoparticles of a metal element (e.g., neat metal, (e.g., Ag)). For example, the redox active compound (e.g., AgNO₃) be reduced by the moieties of the polymer binder and/or by the carbonaceous material. Likewise, moieties of the polymer binder and/or the carbonaceous material may be oxidized by the redox active compound (e.g., AgNO₃). The heat treating process may include a redox process to provide the nanoparticles by reduction of the redox active compound, e.g., reduction of silver cation to metallic silver (e.g., neat silver).

In one or more embodiments, the slurry includes about 1 wt % to about 99.5 wt %, about 5 wt % to about 95 wt %, about 5 wt % to about 80 wt %, about 5 wt % to about 60 wt %, about 10 wt % to about 50 wt %, or about 40 wt % to about 90 wt % of the carbonaceous material, based on a total weight of the slurry.

In one or more embodiments, the slurry includes about 0.01 wt % to about 99 wt %, about 0.1 wt % to about 50 wt %, about 0.1 wt % to about 20 wt %, or about 1 wt % to about 10 wt % of the redox active compound (e.g., AgNO₃), based on a total weight of the slurry. In one or more embodiments, a weight ratio of an amount of the redox active compound (e.g., AgNO₃) to an amount of the carbonaceous material may be about 1 to about 100, e.g., about 1 to about 60, about 1 to about 50, about 1 to about 20, about 1 to about 10, or about 1 to about 5.

In one or more embodiments, the slurry includes about 0.01 wt % to about 99 wt %, about 0.01 wt % to about 50 wt %, about 0.1 wt % to about 25 wt %, about 1 wt % to about 15 wt %, about 3 wt % to about 10 wt %, or about 4 wt % to about 8 wt % of the binder, based on a total weight of the slurry. In one or more embodiments, a weight ratio of an amount of the binder to an amount of the redox active compound (e.g., AgNO₃) may be about 1 to about 100, e.g., about 1 to about 60, about 1 to about 50, about 1 to about 20, about 1 to about 10, or about 1 to about 5.

The methods of embodiments of the present disclosure include a single act process to provide route to provide an interlayer including the matrix of the carbonaceous material and the nanoparticles. The methods of the present disclosure exclude chemical additives such as organic reactants, oxidants, reductants, stabilizers and/or the like.

### Method of Operating an Anodeless Battery

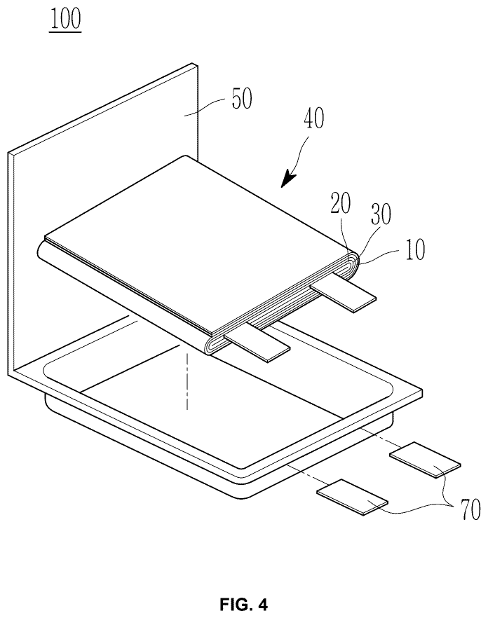

Methods of operating the anodeless battery according to one or more embodiments of the present disclosure include providing a plated anode in the anodeless battery. FIG. 5 shows the interlayer on the anode (e.g., negative electrode) current collector before charging and the plated anode on the anode (e.g., negative electrode) current collector after the first charge, and between the interlayer and the anode (e.g., negative electrode) current collector of the anodeless battery.

The methods may include operating an anodeless all-solid-state battery (ASSB) to provide a plated anode in the ASSB, and/or operating an all-solid-state lithium metal battery (ASSLMB) to provide a plated anode in the ASSLMB.

In one or more embodiments, the plated anode may include metal elements, metal alloys, metal compounds, or a combination thereof. For example, the plated anode may include lithium metal, lithium alloys, lithium compounds, or combinations thereof. The metal (e.g., lithium metal) that is plated on the anode (e.g., negative electrode) current collector may migrate from a component of the anodeless battery. The metal (e.g., lithium metal) may migrate from the cathode active material of the positive electrode, from the solid-state electrolyte, or combinations thereof.

The methods may include discharging the anodeless battery to remove the plated anode.

Hereinafter, referring to examples and comparative examples, the interlayer according to one or more embodiments and an anodeless battery according to one or more embodiments of the disclosure are described in more detail. In some embodiments, the following examples are intended to assist understanding of the disclosure, and the scope of the disclosure is not limited thereto.

### EXAMPLES

### Preparation of Composite Solid-State Electrolytes

Table 1 displays the properties of the raw materials used to prepare the polymer compositions of Examples 1.1 to 1.3, 2.1 to 2.4 and Comparative Examples 1 to 3 according to embodiments of the present disclosure.

TABLE 1

| | Mol. Wt. | Density | |
|---|---|---|---|
| | (g/mol) | (g/cc) | Supplier |
| carbon powder | 12 g/mol | about 2.0 | Cabot Corp. |
| AgNO₃ | 169.87 | about 4.35 | Fisher Scientific Inc. |
| polyvinyl alcohol | 150,000 | about 1.30 | Sigma Aldrich |
| 8 wt % solution | | | |

### Example 1.1

Example 1.1 (“EX 1.1”) was prepared by adding carbon powder (1 g), AgNO₃ (0.236 g), and polyvinyl alcohol (PVA as 8 wt % solution) (0.1 g) in 3 g of deionized water followed by mixing at 2000 rpm for 3 min (ARE-310 THINKY USA INC.) to generate a homogeneous and flowable slurry. The amount of AgNO₃ was sufficient to provide 15 wt % Ag based on a total amount of the carbon powder. The amount of PVA was 42.37 wt % based on a total amount of the AgNO₃. The slurry was coated onto a Ni/Cu foil (current collector, LOTTE Chemical), using doctor blade conditions including 20 micrometer (μm) gap at a speed of 0.5 centimeter per second (cm/s) (Elcometer), and heat treated at a temperature of 120° C. for 1 hour (h) to provide an interlayer of the present disclosure on the current collector. Heat treating (drying) provided nanoparticles of metallic silver that were formed by reduction of silver cation in AgNO₃.

### Examples 1.2 and 1.3

Examples 1.2 and 1.3 (“EX 1.2” and “EX 1.3”) are interlayers prepared according to substantially the same method as Example 1.1 except that the amount of AgNO₃ used was sufficient to provide 15.75 wt % Ag and 23.62 wt % Ag, respectively, based on the total amount of the carbon powder.

### Examples 2.1 to 2.4

Examples 2.1, 2.2, 2.3 and 2.4 are interlayers prepared according to substantially the same method as Example 1.3 except that heat treating (drying) time was adjusted to 2 h, 4 h, 6 h, and 24 h, respectively.

### Comparative Examples 1 and 2

Comparative Examples 1 and 2 (“CE 1” and “CE 2”) are interlayers prepared according to substantially the same method as Example 1.3 except that heat treating (drying) temperature was 80° C. and the heat treating (drying) time was adjusted to 2 h and 72 h, respectively.

The extent of reduction (conversion) of silver cation to the nanoparticles of metallic silver was determined. The nanoparticles were analyzed by with X-ray powder diffraction (XRD) analysis to determine average particle diameter at Miller indices of

The results are shown in Table 2.

TABLE 2

| | Drying | Drying | Nanoparticle | Nanoparticle |
|---|---|---|---|---|
| | temperature | time | formation | diameter |
| | (° C.) | (h) | (%) | (nm) |
| EX 1.3 | 120 | 1 | 28 | 37.6 |
| EX 2.1 | 120 | 2 | 32 | 45.6 |
| EX 2.2 | 120 | 4 | 81 | 54.3 |
| EX 2.3 | 120 | 6 | 85 | 43.8 |
| EX 2.4 | 120 | 24 | 100 | 56.1 |
| CE 1 | 80 | 2 | 6 | 12.0 |
| CE 2 | 80 | 72 | 37 | 25.5 |

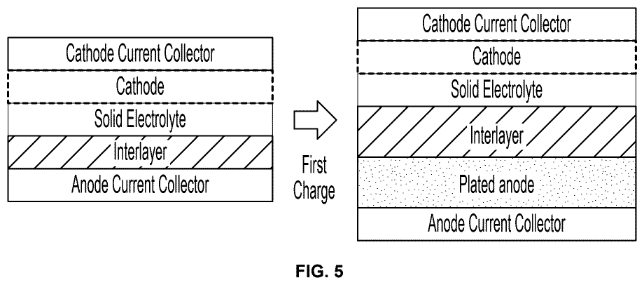

FIG. 6 shows Transmission Electron Microscopy (TEM) images of the interlayers prepared in Examples 1.1, 1.2 and 1.3 having an average particle diameter of about 14.3 nanometer (nm), about 27.6 nm, and about 35.6 nm, respectively, for an amount of Ag of about 15 wt. %, about 16 wt % and about 23 wt %. These results suggest that defect sites on the surface of the carbon powder may provide nucleation spots for the formation of the nanoparticles.

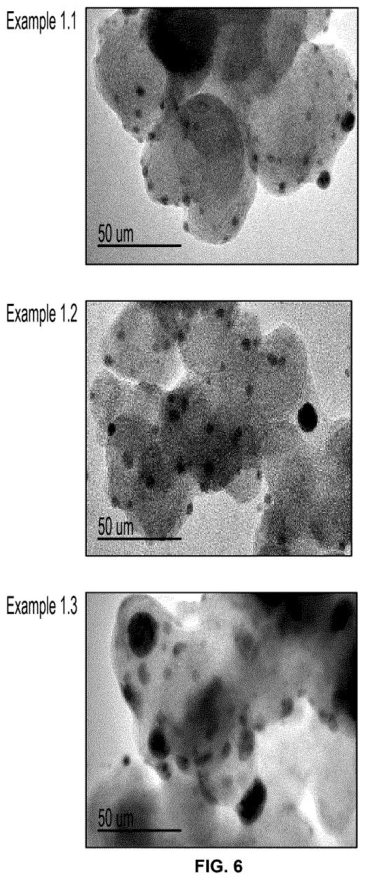

FIG. 7A and FIG. 7B show the results of XRD analysis of Example 1.3 and Example 2.4 dried at a temperature of 120° C. for 1 h and 24 h, respectively. For example, a crystalline form of the interlayer of Example 2.4 exhibited an XRD pattern including characteristic peaks at approximately 38.2, 44.3, and 64.3 degrees 2θ.

These results suggest that the conversion of silver cation, and the average particle size of the nanoparticles was increased with greater heat treating (drying), e.g., temperature and/or time.

### Comparative Example 3

Comparative Example 3 was prepared in substantially the same method as Example 1.1 except that carboxymethyl cellulose (CMC) was used in place of PVA. Rapid gelation was observed that may have occurred from crosslinking between silver cation and carboxylate functional groups of the CMC. In contrast, the non-ionic hydroxyl groups in PVA may avoid undesired gelation to provide stable dispersion and uniform (e.g., substantially uniform) coating of the slurry onto the current collector.

### Example 3: Evaluation of Electrochemical Performance

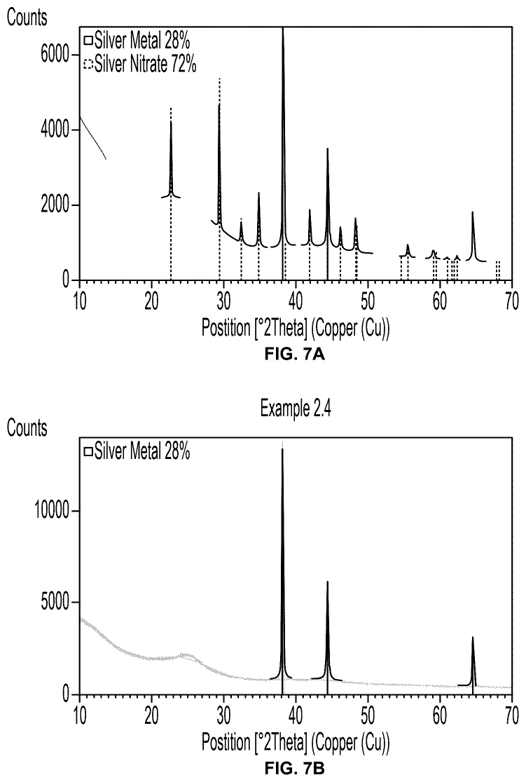

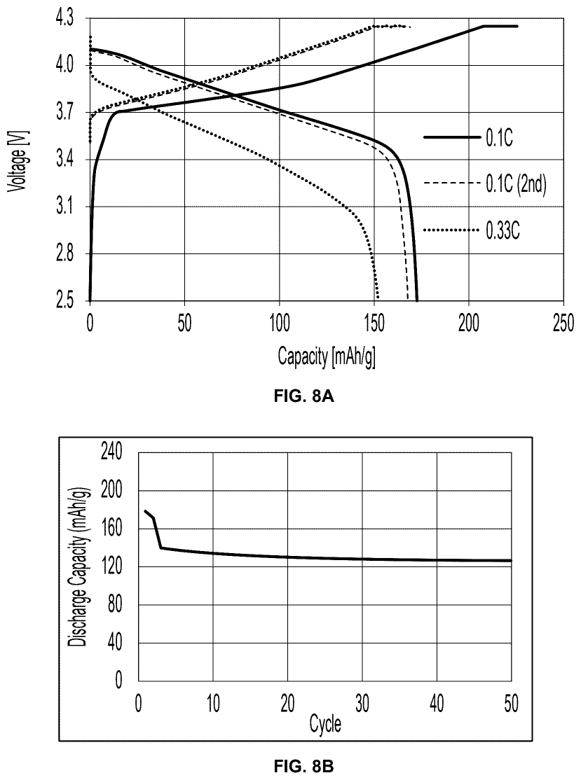

Pouch-type all-solid-state lithium metal battery (ASSLMB) cells were assembled and included the interlayer prepared in Example 2.4, a solid-state electrolyte including Li₆PS₅Cl, and a positive electrode including LiNi_{0.94}Co_{0.02}A_{0.04}O₂ (NCA94) as a positive electrode active material. The electrochemical performance of the ASSLMB cell was measured at 25° C. with current densities of 0.1 C (twice) and 0.33 C and the results are displayed in FIG. 8A, FIG. 8B and FIG. 9.

The ASSLMB cell of embodiments of the present disclosure had well-defined plateaus, stable electrochemical behavior, and suitable rate capability as shown in FIG. 8A and FIG. 8B. The discharge capacity was about 170 milliampere hour per gram (mAh/g) and about 160 mAh/g if (e.g., when) measured at 0.1 C and 0.33 C, respectively.

FIG. 9 demonstrates effective lithium plating and stripping performance and suggests substantially uniform dispersion of the nanoparticles in the interlayer produced in Example 2.4.

### Comparative Example 4

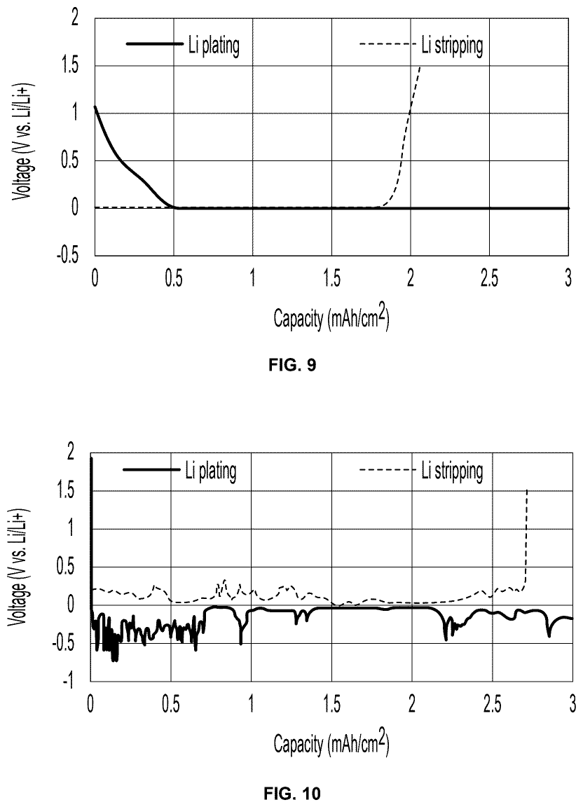

Comparative Example 4 is an ASSLBM cell prepared according to substantially the same method as Example 3 except that no interlayer was included. FIG. 10 demonstrates unstable lithium plating and stripping performance for the ASSLBM cell of Comparative Example 4.

The preceding results demonstrate that the methods of embodiments of the present disclosure provide an interlayer for use in an ASSLMB and include mild heat treating (drying) that facilitates in situ formation of silver nanoparticles well-dispersed in a carbon matrix. The methods of the present disclosure exclude, or do not otherwise require, the use of chemical additives to manufacture the interlayer. The methods of embodiments of the present disclosure are suitable for scalable manufacturing processes.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

What is claimed is:

1. An interlayer comprising:
a binder;
nanoparticles; and
a carbonaceous material,
wherein the interlayer is for an anodeless battery.

2. The interlayer as claimed in claim 1, wherein the binder is water-soluble, soluble in non-aqueous organic solvents, or a combination thereof, and comprises moieties, the moieties comprising hydrogen bond donor groups, hydrogen bond acceptor groups, acidic groups, basic groups, or combinations thereof, and
the moieties comprise at most about 20 mol % of negatively charged groups, based on a total moles of the binder.

3. The interlayer as claimed in claim 1, wherein the binder comprises a polymer composition having at least about 50 mol % of hydrogen bond donor groups, based on a total moles of the binder.

4. The interlayer as claimed in claim 1, wherein the binder comprises a polyvinyl alcohol (PVA) composition having at least about 50 mol % of hydroxyl groups, based on a total moles of the binder.

5. The interlayer as claimed in claim 3, wherein the polymer composition has an average molecular weight of at least about 10,000 Dalton (D).

6. The interlayer as claimed in claim 1, wherein the nanoparticles comprise a metal, a metalloid, an alloy thereof, a compound thereof, or combinations thereof.

7. The interlayer as claimed in claim 1, wherein the nanoparticles comprise silver, gold, platinum, tellurium, antimony, germanium, bismuth, tin, tungsten, molybdenum, cobalt, nickel, copper, iron, or combinations thereof.

8. The interlayer as claimed in claim 1, wherein an average diameter of the nanoparticles is at least about 5 nanometers (nm).

9. The interlayer as claimed in claim 1, wherein the carbonaceous material comprises amorphous carbon, graphite, graphene, reduced graphene oxide, carbon nanotube, or combinations thereof.

10. The interlayer as claimed in claim 1, wherein the interlayer comprises, based on a total weight of the interlayer:
about 5 wt % to about 95 wt % of the carbonaceous material;
about 0.1 wt % to about 50 wt % of the nanoparticles; and
about 0.01 wt % to about 10 wt % of the binder.

11. The interlayer as claimed in claim 1, wherein a thickness of the interlayer is about 1 micrometer (μm) to about 30 μm.

12. An anodeless battery comprising:
a positive electrode;
a negative electrode current collector;
an electrolyte; and
an interlayer comprising the interlayer as claimed in claim 1 and being between the electrolyte and the negative electrode current collector.

13. The anodeless battery as claimed in claim 12, wherein the negative electrode current collector comprises stainless steel, iron, nickel, manganese, copper, titanium, aluminum, or combinations thereof.

14. A method of manufacturing an interlayer comprising:
providing a carbonaceous material, a redox active compound, and a binder to form a slurry;
mixing the slurry;
providing a current collector and applying the slurry to the current collector;
heat treating the slurry and providing the interlayer, the interlayer comprising nanoparticles.

15. The method as claimed in claim 14, wherein the providing of the redox active compound comprises providing at least one compound comprising a metal, a metalloid, or combinations thereof.

16. The method as claimed in claim 14, wherein the providing of the redox active compound comprises providing at least one compound comprising silver.

17. The method as claimed in claim 14, wherein the providing of the current collector comprises a negative electrode current collector or a positive electrode current collector.

18. A method of operating an anodeless battery, the method comprising:
providing an anodeless battery comprising:
a positive electrode comprising a cathode active material;
a negative electrode current collector;
a solid-state electrolyte between the positive electrode and the negative electrode current collector,
an interlayer comprising a binder, nanoparticles, and a carbonaceous material; and
charging the anodeless battery to provide a plated anode.

19. The method as claimed in claim 18, wherein the plated anode comprises metal elements, metal alloys, metal compounds, or combinations thereof.

20. The method as claimed in claim 18, wherein the method further comprises discharging the anodeless battery to remove the plated anode.
